(19) United States
(12) Patent Application Publication
(10) Pub. No.: US 2012/0180613 A1
(43) Pub. Date: Jul. 19, 2012

(54) Anti-Accumulation Wire Conductor Process Blade and Assembly

(75) Inventor: Juan Ruben Lozano, El Paso, TX (US)

(73) Assignee: LAKES PRECISION, INC., Three Lakes, WI (US)

(21) Appl. No.: 13/006,091

(22) Filed: Jan. 13, 2011

(51) Int. Cl. B26D 1/09; B26D 3/16

(52) U.S. Cl. 83/623; 83/697

(57) ABSTRACT

A cutting blade for cutting a wire has a blade body with a cutting face extending from a cutting edge. The body has a slidable surface for engagement with an opposing surface that allows relative movement between the blade body and the opposing surface to permit the cutting edge to cut the wire. The slidable surface and the cutting face preferably are polished to provide a high degree of finish. The cutting edge, cutting face and slidable surface preferably contain a coating to reduce potential cold rewelding. In one embodiment, the coating is polished to provide a high degree of finish. A hollow in the blade body holds one or more cut wire particles to reduce interference by the cut wire particles with the cutting edge, cutting face, and slidable surface. The cutting blade excels in cutting various wires, and particularly wire containing an electrically conducting aluminum core.

### BACKGROUND OF THE INVENTION

This invention relates to a blade for cutting all types of wire, including wire having an aluminum-based core. The wire cutting blade of the present invention can be used in a wire cutting machine or other wire cutting implement and is able to cut wire more efficiently and effectively than prior art blades.

The conventional wire cutting machine includes a cutting head that consists of a pair of cooperating cutting blades. After wire is fed to the cutting head, at least one of the cutting blades operates to sever the wire at a cut point. Examples of such machines include automated wire cutting machines made by Artos Engineering, Schleuniger, and Komax.

The present invention provides an improved wire cutting blade which cuts wire effectively, and, especially wire including aluminum, and has a longer functional lifespan such that it can perform more cutting cycles than prior art blades. Features and advantages of the present invention will become apparent upon reading the disclosure herein, including the drawings.

### OBJECT AND SUMMARY OF THE INVENTION

An object of the present invention is to provide a wire cutting blade which is capable of reducing the accumulation of wire particles on the blade surfaces which might otherwise interfere with the cutting process and reduce the operating life of the wire cutting blade.

In an embodiment, the wire cutting blade has a blade body with a cutting edge and a cutting face extending from the cutting edge. The blade body has a slidable surface for engagement with an opposing surface which allows relative movement between the blade body and the opposing surface to permit the cutting edge to cut the wire. The cutting face and slidable surface preferably are polished to provide a high degree of finish, and a coating is preferably applied to the cutting edge, cutting face and/or slidable surface to reduce cold rewelding. A hollow in the blade body holds one or more cut wire particles to reduce interference by the cut wire particles with the cutting edge, cutting face and/or slidable surface. The hollow preferably functions to reduce the number of particles compressed between the slidable surface and the opposing surface, thereby allowing the cutting blade to cut and/or slide substantially unimpeded during the cutting process.

In a preferred embodiment, the present invention is particularly desirable when cutting aluminum-based wire. Specifically, the present invention decreases accumulation of aluminum material on the working parts of the wire cutting blade that could otherwise build up. The preferred embodiment reduces melting of wire particles to the working parts of the wire cutting blade due to the properties of aluminum and similar materials. The present invention significantly inhibits the buildup of wire particles on the blade cutting edge and cutting surface, as well as the blade slidable surface. Blades incorporating the present invention can functionally operate for a much longer time than prior art blades.

### BRIEF DESCRIPTION OF THE DRAWINGS

The drawings illustrate the best mode presently contemplated of carrying out the disclosure. In the drawings:

FIG. 1 is a plan view of a preferred embodiment of blade for cutting wire;

FIG. 2 is a cross-sectional view of the blade shown in FIG. 1;

FIG. 3 is another embodiment of a blade for cutting wire;

FIG. 4 is a cross-sectional view of the blade shown in FIG. 3; and

FIG. 5 is a cross-sectional view of a pair of blades as illustrated in FIGS. 1 and 2 cooperating in a wire cutting action.

### DESCRIPTION OF THE ILLUSTRATED EMBODIMENTS

The embodiments disclosed are exemplifications and are not intended to limit the invention to the embodiments illustrated and described herein.

Wire with high aluminum content tends to have increased “granular” properties than other types of wire, allowing wire particles to break off during the wire cutting process and accumulate on the cutting edge and cutting surface. In some circumstances, the aluminum particles or particulate bond to the cutting blade, sometimes referred to as cold reweld. Eventually, the increasing volume of accumulated material could reach the point of impeding the cutting process by preventing the blade from sliding against an opposing surface. The accumulation could eventually cause a cutter head operation of a wire cutting machine to stop.

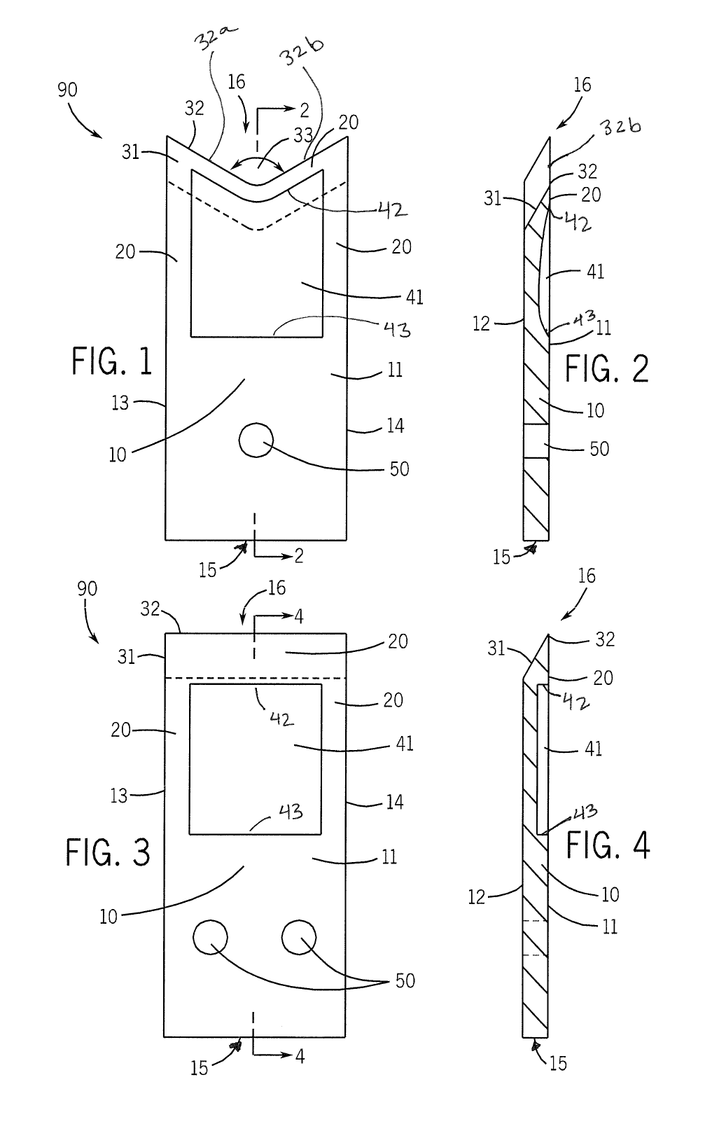

FIG. 1 illustrates a preferred embodiment of a wire cutting blade 90, which may be formed from high carbon steel. A blade body 10 is generally rectangular in shape having a back face 11 and a front face 12 which are joined by side edges 13 and 14, a far end 15 and a cutting end 16. The cutting end 16 is sharpened to form a cutting edge 32 adjacent to a cutting face 31. The cutting face 31 is angled toward the front face 12 of the blade body 10.

The back face 11 has a slidable surface 20 which includes a portion of the blade body 10 that slides against an opposing surface during a cutting action. The back face 11 has a hollow 41, which is a cavity in the blade body 10 spaced from the cutting edge 32. The hollow 41 collects at least a portion of the wire particles or particulate which may accumulate during the cutting process. The hollow 41 retains the collected wire particles or particulate in a loose state which can be readily removed as necessary, such as wiped off or blown off by compressed air. The hollow 41 has a first end 42 adjacent to the cutting edge 32, preferably positioned as close as possible to the cutting edge 32 without significantly degrading the strength of the cutting edge 32. The hollow 41 extends towards the far end 15 of the blade body 10 to a second end 43. The hollow 41 has a depth sufficient to allow collection and containment of dispersed wire particles or particulate to minimize interference with the cutting edge 32, cutting face 31 and/or slidable surface 20 during the cutting process. The hollow 41 preferably has a width at least equal to the largest wire core diameter being processed by the wire cutting blade 90.

As best shown in FIG. 2, the hollow 41 of the preferred embodiment provides a depression in the blade body 10 with a varying depth. The hollow 41 progresses in depth as it extends from its first end 42 adjacent the cutting edge 32 toward its second end 43, which is towards the far end 15 of the blade body 10. The progressive depth configuration of the hollow 41 allows the first end 42 of the hollow 41 to be positioned closely to the cutting edge 32.

FIGS. 3 and 4 depict another embodiment of the invention in which the hollow 41 is rectangular in shape and has a substantially constant depth. The hollow 41 disclosed in FIGS. 1-4 provides a first end following the shape of the blade end 16. The hollow 41 can also have any configuration which minimizes interference of wire particles or particulate with the cutting edge 32, cutting face 31 and/or the slidable surface 20, including any shape, depth, length or width. The hollow 41 may also consist of a hole through the blade body 10.

The geometry of the cutting end 16 may play a role in causing wire particles or particulate to accumulate on the wire cutting blade 90. With blades having V-shaped cutting ends, a narrow cutting angle will tend to compress the aluminum material over a smaller area creating a denser accumulation. Thus, the cutting end 16 illustrated in FIGS. 1 and 2 has a wide cutting angle 33, preferably between 90 degrees and 125 degrees. FIG. 1 illustrates a wire cutting blade 90 with a V-shaped cutting end 16 having a preferred cutting angle 33 of approximately 120 degrees. However, alternate embodiments include blades with cutting angles 33 outside the angle range of the preferred embodiment, including blades with flat cutting ends 16 as depicted in FIGS. 3 and 4.

Preferably, in order to reduce the accumulation of wire particles or particulate at or near the cutting edge 32, cutting face 31 and slidable surface 20 during the cutting process, the cutting face 31 and the slidable surface 20 are polished. It is preferred to polish portions of the blade to a high degree of finish, such as a mirror finish, in order to reduce roughness which might otherwise rasp-off aluminum particles from the conductor core during the cutting process and gall the surface of the blade. Additionally, the cutting edge 32, cutting face 31 and slidable surface 20 preferably have a coating to reduce cold rewelding and triboelectric effects from the wire particles. Such coating may include any one of a number of materials which reduce cold rewelding of the particulate material to the body metal. Such coating may also exhibit a low to mid-range friction coefficient and is wear resistant to provide extended life. In a preferred embodiment, the coating includes a metal nitride, such as Zirconium Nitride, although other metals could be used together with other materials similar to Nitrides, such as, for example, Carbo-Nitride. In a preferred embodiment, a coating of Zirconium Nitride of one to four microns with a friction coefficient against steel (dry) of 0.5 has been found to be highly desirable. The coating can be deposited by conventional vapor disposition techniques, including physical vapor deposition (PVD) or chemical vapor deposition (CVD).

The wire cutting blade 90 provides a mounting structure 50 for removably attaching the wire cutting blade 90 to a wire cutting machine or implement, such as that disclosed in U.S. Pat. No. 5,979,272 which is incorporated herein. The mounting structure 50 can consist of various configurations for mating with a blade mounting fixture of any type of wire cutting machine or implement. For example, the mounting structure 50 depicted in FIGS. 1 and 2 features one or more a circular holes for receiving a bolt, stud, lug, etc. located on the cutter head of a cutting machine or implement. Alternatively, the cutting blade 90 may be configured to provide an integral bolt, stud, lug, etc. as a mounting structure 50 for attachment to a cutting machine or implement. Alternatively, the wire cutting blade 90 could be permanently or semi-permanently mounted to a cutting machine or implement by welding, gluing, tacking, etc.

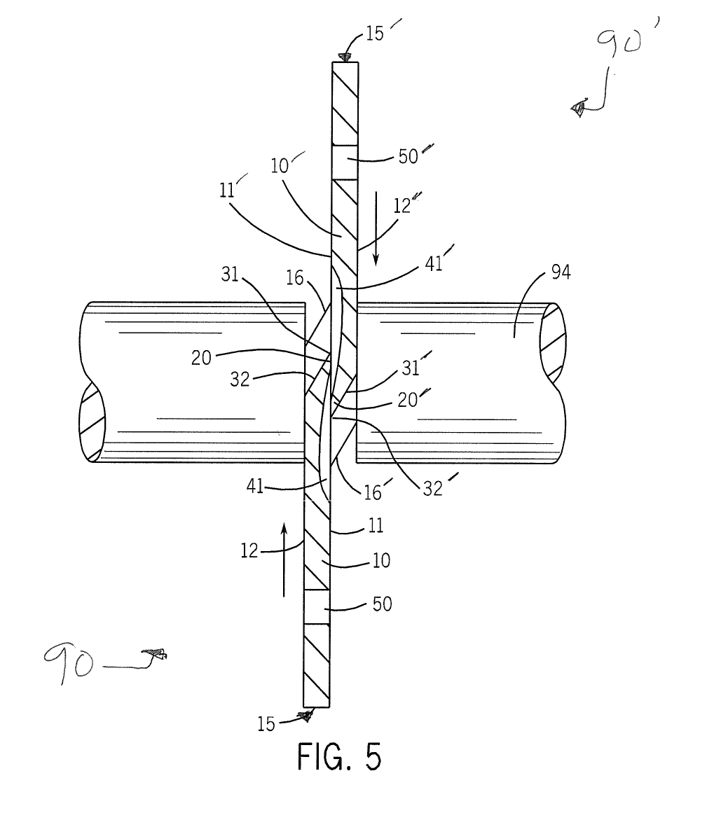

FIG. 5 illustrates a pair of wire cutting blades 90 and 90′ of the preferred embodiment depicted in FIGS. 1 and 2 which cooperate to cut a wire 94, as might occur, for example, in a wire cutting machine. The elements of the second blade illustrated in FIG. 5 which are the same as or similar to the elements of the blade in FIGS. 1 and 2 will be identified by the same numbers primed. When cutting the wire 94, the pair of wire cutting blades 90 and 90′ slidably engage each other. Relative movement occurring between the wire cutting blades 90 and 90′ severs the wire 94. During cutting, the slidable surfaces 20 and 20′, which preferably have a coating to reduce the accumulation of cut wire particles, slide against one another. Cutting can be accomplished by having one wire cutting blade 90 or 90′ move while the other is held stationary, or by having both wire cutting blades 90 and 90′ move. The hollows 41 and 41′ contain wire particles or particulate that break off of the wire 94 during the cutting process to reduce interference of the particles or particulate with the slidable surfaces 20 and 20′, cutting faces 31 and 31′ and cutting edges 32 and 32′.

Various modes of carrying out the invention are contemplated as being within the scope of the following claims particularly pointing out and distinctly claiming the subject matter which is regarded as the invention.

I claim:

1. A cutting blade for cutting a wire, the cutting blade comprising
a blade body;
a cutting edge on the blade body;
a slidable surface on the blade body for engagement with an opposing surface, the slidable surface allowing relative movement between the blade body and the opposing surface to permit the cutting edge to cut the wire; and
a hollow in the blade body to hold one or more cut wire particles to reduce interference by the cut wire particles with the operation of the blade.

2. The cutting blade of claim 1, wherein the hollow includes a depression having a first end adjacent to the cutting edge and a second end spaced from the first end, the depression having a first depth adjacent the first end which is less than a second depth adjacent the second end.

3. The cutting blade of claim 2, wherein the depression progressively varies in depth between the first and second ends.

4. The cutting blade of claim 1, wherein the hollow has a width equal to or greater than the diameter of the wire being cut.

5. The cutting blade of claim 1, wherein the hollow has an edge at a first end adjacent to the cutting edge which is spaced generally equidistant from the cutting edge.

6. The cutting blade of claim 1, and including a cutting face adjacent to the cutting edge and coating located on at least a portion of the cutting face to reduce the accumulation of the cut wire particles.

7. The cutting blade of claim 6, wherein the coating consists of Zirconium Nitride.

8. The cutting blade of claim 1, and including a cold reweld reducing coating on the slidable surface to reduce the accumulation of the cut wire particles on the slidable surface.

9. The cutting blade of claim 8, wherein the coating consists of Zirconium Nitride.

10. The cutting blade of claim 1, wherein the cutting edge is V-shaped.

11. The cutting blade of claim 10, wherein the V-shaped cutting edge has a first edge portion and a second edge portion angularly spaced between ninety degrees and one hundred and twenty-five degrees.

12. The cutting blade of claim 1, and including a cutting face adjacent the cutting edge, at least a portion of the cutting face is polished to reduce the accumulation of cut wire particles.

13. The cutting blade of claim 1, wherein at least a portion of the slidable surface is polished to reduce the accumulation of the cut wire particles.

14. The cutting blade of claim 1, wherein the blade body has a front face and a back face, the back face having the slidable surface and the hollow, and the front face having the cutting face extending from the cutting edge.

15. A system for cutting wire, comprising:
a first blade body having a first cutting edge;
a second blade body having a second cutting edge;
a first slidable surface on the first blade body that slidably engages a second slidable surface on the second blade body to allow relative movement therebetween to permit the first cutting edge and the second cutting edge to cut a wire; and
at least one of the first blade body and the second blade body having a hollow to hold one or more cut wire particles to reduce interference by the cut wire particles with the slidable surfaces.

16. The system of claim 15, wherein the first blade body and the second blade body are mounted in a wire cutting machine.

17. The system of claim 15, wherein the hollow is located on the same side of the first blade body as the first slidable surface.

18. The system of claim 15, wherein the first blade body has a first hollow located on same side of the first blade body as the first slidable surface, and the second blade body has a second hollow located on the same side of the second blade body as the second slidable surface.

19. The system of claim 15, wherein the first and second blade bodies provide first and second cutting faces respectively, and at least one of the first cutting face, the second cutting face, the first slidable surface, and the second slidable surface has a coating to reduce the accumulation of cut wire particles on the cutting faces and the slidable surfaces.

20. The system of claim 15, wherein the wire includes an electrical conductor containing aluminum.

21. A cutting blade for cutting a wire, a portion of which includes aluminum, the cutting blade comprising
a blade body having a front face and a back face;
a cutting edge on the blade body;
a cutting face on the front face of the blade body extending from the cutting edge;
a slidable surface on the back face of the blade body for engagement with an opposing surface, the slidable surface allowing relative movement between the blade body and the opposing surface to permit the cutting edge to cut the wire;
at least a portion of the cutting face and the slidable surface being polished to provide a high degree of finish to reduce the accumulation of cut wire particles on the cutting face and the slidable surface;
at least a portion of the cutting face and the slidable surface including a coating to reduce the accumulation of cut wire particles on the cutting face and the slidable surface; and
a hollow in the back face of the blade body to hold one or more cut wire particles to reduce interference by the cut wire particles with the slidable surface.
